(19) United States
(12) Patent Application Publication
(10) Pub. No.: US 2025/0323440 A1
(43) Pub. Date: Oct. 16, 2025

(54) ELECTRICAL CONNECTOR FOR FLAT CONDUCTOR

(71) Applicant: HIROSE ELECTRIC CO., LTD., Kanagawa (JP)

(72) Inventor: Sae YOKOYAMA, Kanagawa (JP)

(21) Appl. No.: 19/098,432

(22) Filed: Apr. 2, 2025

(30) Foreign Application Priority Data
Apr. 16, 2024 (JP) 2024-065959

(51) Int. Cl. H01R 12/77; H01R 12/88; H01R 13/424; H01R 13/629

(52) U.S. Cl. CPC H01R 12/77; H01R 12/88; H01R 13/424; H01R 13/62988

(57) ABSTRACT

Provided is an electrical connector to which a flat conductor is connected includes: a housing; terminals; and a movable member, the movable member is movable between a closed position and an open position while rotating, each terminal has an arm part, the movable member maintains a connection state between the electrical connector and the flat conductor when being located in the closed position and allows removal of the flat conductor when being located in the open position, and has a groove that houses a rear end portion of the arm part, when the movable member is located in a predetermined position different from the closed position, the rear end portion is housed in a wide portion of the groove, and when the movable member is located in the closed position, the rear end portion is housed in the wide portion and a narrow portion of the groove.

### CROSS-REFERENCE TO RELATED APPLICATION

This application claims priority from Japanese Patent Application No. 2024-065959 filed with the Japan Patent Office on Apr. 16, 2024, the entire content of which is hereby incorporated by reference.

### BACKGROUND

### 1. Technical Field

The present disclosure relates to an electrical connector for a flat conductor.

### 2. Description of the Related Art

There are known connectors into which a strip-shaped flat conductor extending in the front-rear direction and having a thickness in the up-down direction is inserted forward for connection. For example, in the connector described in JP-A-2015-015126, a plurality of terminals arranged in a terminal arrangement direction in the strip width direction of a flat conductor is held in a housing. Each terminal has an upper arm part and a lower arm part that extend parallel to each other in the front-rear direction, and a coupling part that extends in the up-down direction and couples the front ends of the upper arm part and the lower arm part to each other. In other words, each terminal is substantially U-shaped opening rearward as viewed in the terminal arrangement direction, and is adapted to receive the flat conductor between the upper arm part and the lower arm part. The upper arm part has a contact portion at the rear end side that protrudes downward, and the contact portion contacts the circuit part on the upper surface of the flat conductor from above.

The connector of JP-A-2015-015126 is provided with a movable member that can rotate around an axis extending in the terminal arrangement direction. The movable member can rotate between a closed position in which it is parallel to the flat conductor and an open position in which it is upright relative to the flat conductor. This movable member prevents the flat conductor from being removed when in the closed position, and allows the flat conductor to be removed when in the open position. The movable member has grooves formed at its rear end when in the closed position (its lower end when in the open position) that accommodate the rear ends of the upper arm parts of the terminals.

### SUMMARY

An electrical connector for a flat conductor according to an embodiment of the present disclosure is an electrical connector for a flat conductor to which a flat conductor is connected, the electrical connector including: a housing; a plurality of terminals; and a movable member, in which the plurality of terminals is held in the housing and arranged in a left-right direction perpendicular to a front-back direction and an up-down direction of the electrical connector for a flat conductor, the movable member is movable between a closed position and an open position while rotating about a rotation axis extending in the left-right direction, the housing is configured such that the flat conductor is insertable from rear to front of the housing, each of the plurality of terminals has an arm part extending from the front to the rear of the housing, the arm part being able to contact the flat conductor inserted into the housing, the movable member is configured to maintain a connection state between the electrical connector for a flat conductor and the flat conductor when being located in the closed position, and to allow removal of the flat conductor from the electrical connector for a flat conductor when being located in the open position, the movable member has a groove that houses a rear end portion of the arm part, the groove has a wide portion and a narrow portion narrower in groove width than the wide portion, and when the movable member is located in a predetermined position different from the closed position, the rear end portion of the arm part is housed in the wide portion, and when the movable member is located in the closed position, the rear end portion of the arm part is housed in the wide portion and the narrow portion.

### BRIEF DESCRIPTION OF THE DRAWINGS

FIG. 1 is a perspective rear view of an electrical connector for a flat conductor according to an embodiment of the present disclosure, illustrating the electrical connector for a flat conductor in a state immediately prior to connection of a flat conductor, and the flat conductor;

FIGS. 2A and 2B are perspective views of the electrical connector for a flat conductor according to the embodiment of the present disclosure, FIG. 2A is a rear view of the electrical connector for a flat conductor immediately prior to removal of the flat conductor, and the flat conductor, and FIG. 2B is a front view of only the electrical connector for a flat conductor in FIG. 2A;

FIG. 3 is a perspective view of the electrical connector for a flat conductor in which a housing, terminals, metal fittings, and a movable member are separated;

FIG. 4A is a perspective view of the housing of the electrical connector for a flat conductor, and FIG. 4B is a longitudinal sectional perspective view of the electrical connector for a flat conductor at the position of an outer shaft part in the connector width direction;

FIGS. 5A and 5B are longitudinal cross-sectional views of the electrical connector for a flat conductor at the position of the terminal in the connector width direction, FIG. 5A illustrates the movable member in a closed position, and FIG. 5B shows the movable member in an open position;

FIG. 6A is a transverse cross-sectional view of the electrical connector for a flat conductor at the position of grooves in the movable member in the up-down direction, and FIG. 6B is an enlarged view of a portion of FIG. 6A;

FIG. 7A is a plan view of the movable member, FIG. 7B is an enlarged view of a portion of FIG. 7A, and FIG. 7C is a longitudinal cross-sectional view of the movable member at the position of the grooves in the connector width direction;

FIG. 8A is a plan view of the electrical connector for a flat conductor, and FIG. 8B is an enlarged view of a portion of FIG. 8A;

FIGS. 9A and 9B are longitudinal cross-sectional views of the electrical connector for a flat conductor immediately prior to insertion of the flat conductor, FIG. 9A illustrates the longitudinal cross-section of the electrical connector for a flat conductor at the position of the terminal, and FIG. 9B illustrates the longitudinal cross-section of the electrical connector for a flat conductor at a position adjacent to a locking part of the movable member;

FIGS. 10A and 10B are longitudinal cross-sectional views of the electrical connector for a flat conductor in which the insertion of the flat conductor is complete, FIG. 10A illustrates the longitudinal cross-section of the electrical connector for a flat conductor at the position of the terminal, and FIG. 10B illustrates the longitudinal cross-section of the electrical connector for a flat conductor at a position adjacent to the locking part of the movable member; and

FIGS. 11A and 11B are longitudinal cross-sectional views of the electrical connector for a flat conductor immediately prior to removal of the flat conductor, FIG. 11A illustrates the longitudinal cross-section of the electrical connector for a flat conductor at the position of the terminal, and FIG. 11B illustrates the longitudinal cross-section of the electrical connector for a flat conductor at a position adjacent to the locking part of the movable member.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In JP-A-2015-015126, during assembly of the connector, at the time when the movable member is attached to the housing, each terminal is held in the housing, and the rear end of the upper arm part of the terminal is inserted into the groove in the movable member. At this time, if the relative positions of the rear end of the upper arm part and the groove are significantly misaligned in the terminal arrangement direction, the rear end will abut against the partition wall separating the grooves in the movable member. Therefore, it is preferable that the grooves are formed with a sufficiently large width.

However, if the groove width is increased, when the connector is used, that is, when the contact portion of the upper arm part of each terminal is in contact with the circuit part of the flat conductor, a large gap is formed between the rear end of the upper arm part and the inner surface of the groove in the terminal arrangement direction. Thus, the rear end of the upper arm part and also the contact portion may be displaced within the range of this gap. Therefore, in order to more reliably bring the contact portion and the flat conductor into contact at the correct position, it is preferable to form the groove with as small a width as possible to reduce the gap. That is, the requirements for the magnitude of the groove width are in conflict between the objective of achieving easy assembly of the connector and the objective of maintaining a favorable electrical connection state.

In view of the above circumstances, an object of the present disclosure is to provide an electrical connector for a flat conductor that is easy to assemble and maintain a favorable contact between the terminals and the flat conductor.

(1) An electrical connector for a flat conductor according to the present disclosure is an electrical connector for a flat conductor to which a flat conductor is connected, the electrical connector including: a housing; a plurality of terminals; and a movable member, in which the plurality of terminals is held in the housing and arranged in a left-right direction perpendicular to a front-back direction and an up-down direction of the electrical connector for a flat conductor, the movable member is movable between a closed position and an open position while rotating about a rotation axis extending in the left-right direction, the housing is configured such that the flat conductor is insertable from rear to front of the housing, each of the plurality of terminals has an arm part extending from the front to the rear of the housing, the arm part being able to contact the flat conductor inserted into the housing, the movable member is configured to maintain a connection state between the electrical connector for a flat conductor and the flat conductor when being located in the closed position, and to allow removal of the flat conductor from the electrical connector for a flat conductor when being located in the open position.

In the electrical connector for a flat conductor, the movable member has a groove that houses a rear end portion of the arm part, the groove has a wide portion and a narrow portion narrower in groove width than the wide portion, and when the movable member is located in a predetermined position different from the closed position, the rear end portion of the arm part is housed in the wide portion, and when the movable member is located in the closed position, the rear end portion of the arm part is housed in the wide portion and the narrow portion.

In the present disclosure, when the movable member is in the predetermined position different from the closed position, the rear end portion of the terminal is placed in the wide portion of the groove of the movable member. Therefore, during assembly of the connector, when the rear end portion of the arm part of the terminal is inserted into the wide portion with the movable member in the predetermined position different from the closed position, the rear end portion of the arm part can be easily inserted into the groove without colliding with the movable member. This makes it easier to assemble the connector, and effectively avoids damage to the terminal due to buckling or the like of the arm part.

In addition, in the present disclosure, when the electrical connector for a flat conductor is in use, that is, when the electrical connector for a flat conductor is connected with the flat conductor, the movable member is in the closed position, and the rear end portion of the arm part of the terminal is placed in the wide portion and narrow portion of the groove of the movable member. Therefore, the inner surface of the groove of the narrow portion restricts the displacement of the rear end portion of the arm part in the terminal arrangement direction, and the contact position of the arm part of the terminal with the flat conductor in the terminal arrangement direction is stabilized. As a result, the contact state between the arm part and the flat conductor is favorably maintained.

(2) In the disclosure of (1), the narrow portion may have a first narrow portion located behind the wide portion and a second narrow portion located in front of the wide portion when the movable member is located in the closed position.

As above, in the movable member in the closed position, providing the narrow portions, that is, the first narrow portion at the front and the second narrow portion at the rear, on both sides of the wide portion in the front-rear direction more favorably restricts the displacement of the rear end portion of the arm part of the terminal in the terminal arrangement direction. Therefore, the position of the arm part of the terminal is more stable, and the contact state between the arm part and the flat conductor is more favorably maintained.

(3) In the disclosure of (2), the arm part may be configured to be elastically displaced in the up-down direction when in contact with the flat conductor, when the arm part is not in contact with the flat conductor and the movable member is located in the closed position, an opposing area between the rear end portion of the arm part and a groove inner surface of the first narrow portion may be larger than an opposing area between the rear end portion of the arm part and the second narrow portion, and when the arm part is in contact with the flat conductor and the movable member is located in the closed position, the opposing area between the rear end portion of the arm part and a groove inner surface of the second narrow portion may be larger than the opposing area between the rear end portion of the arm part and the first narrow portion.

In this configuration, when the arm part of the terminal is not in contact with the flat conductor but is in a free state, the rear end portion of the arm part is restricted from displacement in the terminal arrangement direction mainly by the groove inner surface of the first narrow portion. On the other hand, when the arm part of the terminal is in contact with the flat conductor and is in an elastically displaced state, the rear end portion of the arm part is restricted from displacement in the terminal arrangement direction mainly by the groove inner surface of the second narrow portion. Therefore, whether the arm part of the terminal is in a free state or an elastically displaced state, the displacement of the rear end portion of the arm part is restricted by a sufficient opposing area of the groove inner surface of at least one of the first narrow portion and the second narrow portion. As a result, the position of the arm part in the terminal arrangement direction can always be stabilized regardless of which of the above-mentioned states the arm part of the terminal is in.

In the disclosure of any one of (1) to (3), the groove may have a transition portion between the wide portion and the narrow portion, and the transition portion may be formed so as to be narrower in groove width from the wide portion toward the narrow portion.

With the provision of the transition portion, the inner surface of the groove between the wide portion and the narrow portion is formed as a smooth surface without corners. Therefore, when the rear end portion of the arm part of the terminal is inserted into the wide portion during assembly of the connector, and when the movable member is moved between the open position and the closed position during use of the connector, the rear end portion of the arm part is less likely to interfere with the inner surface of the groove. As a result, it is possible to effectively avoid damage to the movable member and the terminal.

(5) In the disclosure of (4), a groove inner surface of the transition portion may form a flat inclined surface.

As above, if the inner surface of the groove at the transition portion is a flat inclined surface, the portion of the mold corresponding to the transition portion has a simple shape, which makes it easier to manufacture the mold.

(6) In the disclosure of any one of (1) to (5), the movable member may be made of an electrically insulating material, and a groove inner surface of the wide portion may have a parting line formed by one mold placed from one side in a thickness direction of the movable member and another mold placed from the other side.

In this configuration, during molding of the movable member, the mating surfaces between one mold and the other mold at the position corresponding to the groove are located in the wide portion, not in the narrow portion. This makes it possible to increase the width of the portions corresponding to the wide portion in both molds, and as a result, sufficient strength of those portions can be ensured.

According to the present disclosure, it is possible to provide an electrical connector for a flat conductor that is easy to assemble and in which favorable contact between the terminals and the flat conductor can be easily maintained.

Hereinafter, embodiments of the present disclosure will be described with reference to the drawings.

An electrical connector for a flat conductor 1 (hereinafter, referred to as “connector 1”) according to the present embodiment is mounted on the mounting surface of a circuit board (not illustrated). A flat conductor C (for example, FPC) as a mating connector is connected to the connector 1 so as to be insertable and removable in a front-back direction (X-axis direction) parallel to the mounting surface as insertion/removal direction. The connector 1 brings the circuit board and the flat conductor C into electrical conduction by connection with the flat conductor C.

In the present embodiment, in the X-axis direction (front-back direction), an X1 direction is the forward direction, and an X2 direction is the backward direction. A Y-axis direction perpendicular to the front-back direction (X-axis direction) is the connector width direction, and a Z-axis direction perpendicular to the mounting surface of the circuit board is the up-down direction.

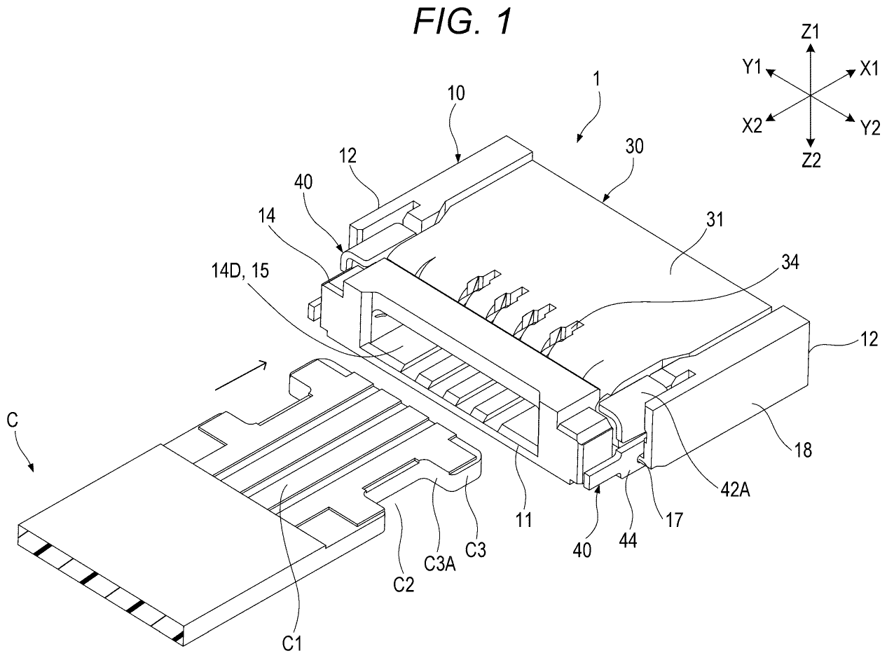

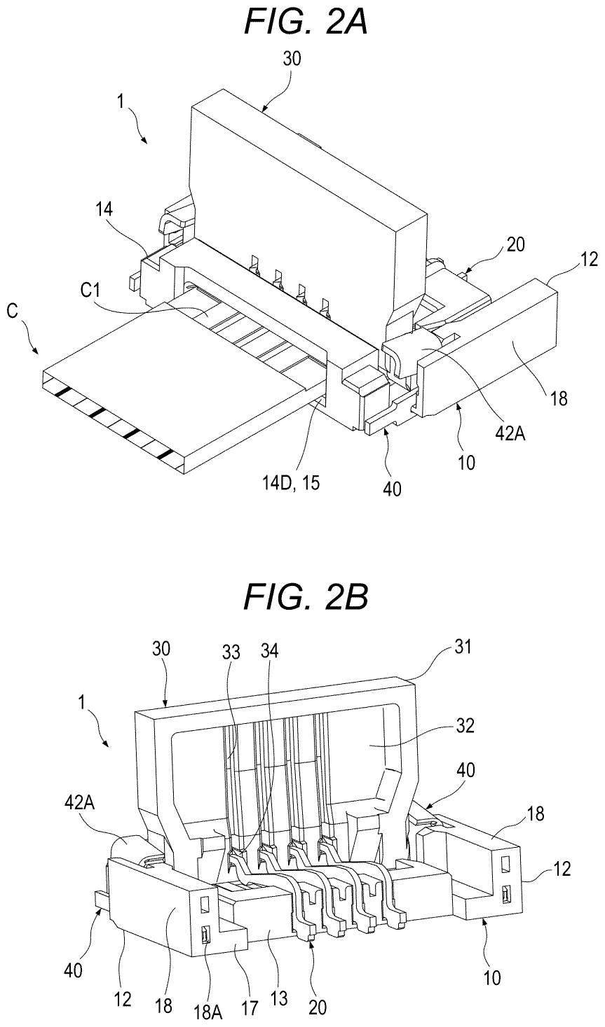

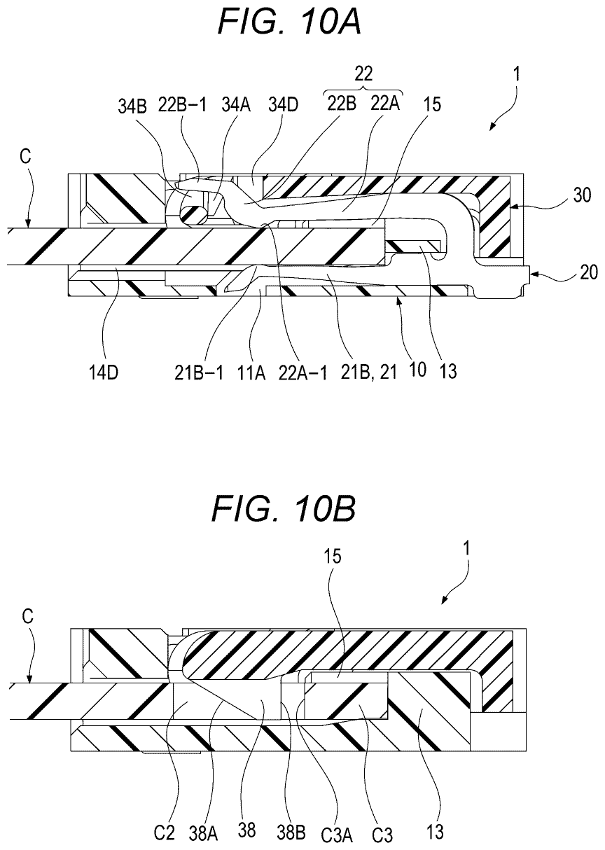

As illustrated in FIG. 1, the flat conductor C has a flexible strip-shaped conductor that extends in the front-back direction (X-axis direction), with the connector width direction (Y-axis direction) as the strip width direction, and the up-down direction (Z-axis direction) as the thickness direction. As illustrated in FIG. 2A, the front end of the flat conductor C is inserted into a housing 10 of the connector 1. In the flat conductor C, a plurality of circuit parts C1 extending in the front-back direction is arranged and formed in the connector width direction. The circuit parts C1 are embedded in the insulating layer of the flat conductor C and extend in the front-back direction. A portion of each circuit part C1 extending in the forward direction reaches a position near the front end of the flat conductor C. In addition, each circuit part C1 is exposed on the upper surface of the front end of the flat conductor C, and can come into contact with terminals 20 of the connector 1 (see FIG. 10A).

As illustrated in FIG. 1, cut parts C2 and ear parts C3 are formed on side edges of the front end of the flat conductor C. The ear parts C3 are located in front of the cut parts C2, and the rear edge of each ear part C3 functions as a locked portion C3A that is locked by a locking part 38 of the connector 1, as described later (see FIG. 10B).

As illustrated in FIGS. 1 to 3, the connector 1 includes the housing 10 made of an electrically insulating material such as resin, the plurality of terminals 20 that is made of metal plates arranged in the connector width direction as the terminal arrangement direction and is held in the housing 10, a movable member 30 that is made of an electrically insulating material such as resin and is movable between the closed position (see FIG. 1) and the open position (see FIGS. 2A and 2B), and metal fittings 40 that are arranged on both outsides of the terminal arrangement range in the connector width direction and are held in the housing 10. The flat conductor C is inserted and connected to the connector 1 from behind (see the arrow illustrated in FIG. 1).

As illustrated in FIGS. 1 to 4B, the housing 10 has a bottom wall 11 facing the mounting surface of the circuit board, two side parts 12 coupled to both ends of the bottom wall 11 in the connector width direction, a front wall 13 coupled to the front end of the bottom wall 11, and an introduction part 14 coupled to the rear ends of the bottom wall 11 and the side parts 12. The housing 10 also has a receiving portion 15, which is a space extending along the upper surface of the bottom wall 11, so that the front end of the flat conductor C inserted from behind can be received in the receiving portion 15.

The connector width direction (Y-axis direction, terminal arrangement direction) is the left-right direction of the connector 1 and is perpendicular to the front-back direction of the connector 1 (X-axis direction) and the up-down direction of the connector 1 (Z-axis direction, thickness direction).

The closed position of the movable member 30 is a position where the movable member 30 is parallel to the front-back direction and left-right direction of the connector 1. The open position of the movable member 30 is a position where the movable member 30 is parallel to the up-down direction (thickness direction) of the connector 1.

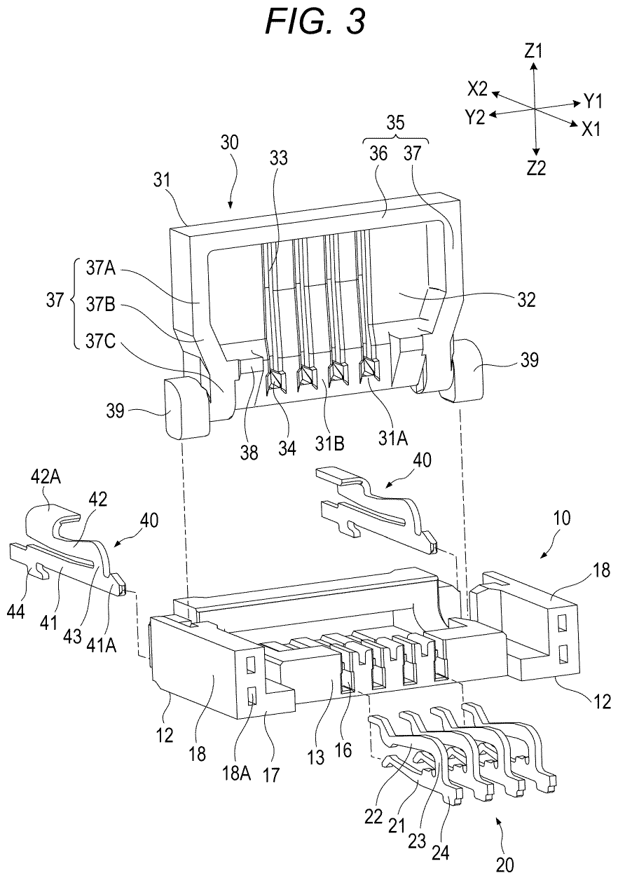

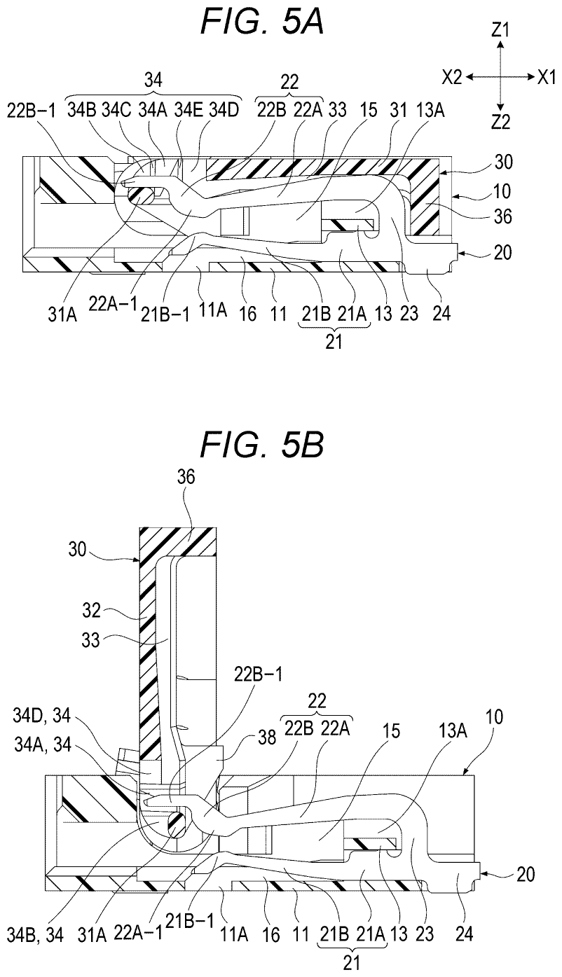

As illustrated in FIGS. 3, 4A, 5A, and 5B, the housing 10 is formed with lower housing parts 16 arranged in the connector width direction, which can house lower arm parts 21 of the terminals 20. The lower housing parts 16 are formed in a groove shape extending in the front-back direction over the range of approximately the front half of the bottom wall 11 and the front wall 13 in the front-back direction. Specifically, as illustrated in FIGS. 5A and 5B, the lower housing parts 16 are open upward in the range of approximately the front half of the bottom wall 11, and penetrate the front wall 13 in the front-back direction within the range of the front wall 13.

As illustrated in FIGS. 5A and 5B, the lower wall 11 has a hole 11A formed therein. The hole 11A passes through the lower wall 11 in the up-down direction directly below the rear end of the lower arm part 21 of the terminal 20 and communicates with the lower housing part 16. The hole 11A is adapted to receive the rear end of the lower arm part 21 when the lower arm part 21 is elastically displaced downward (see FIG. 10A). This avoids interference between the rear end of the lower arm part 21 and the lower wall 11.

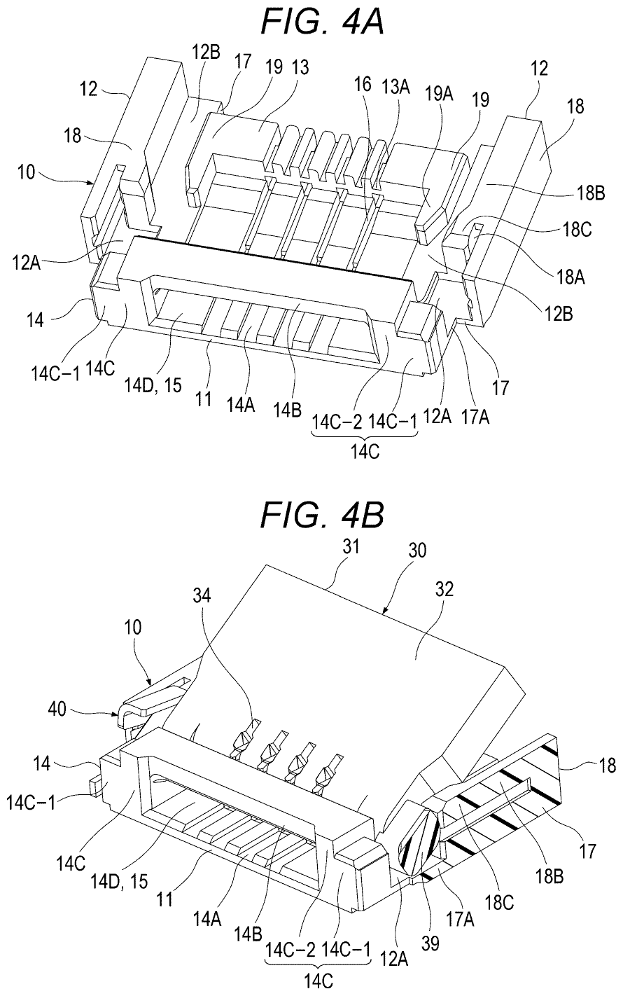

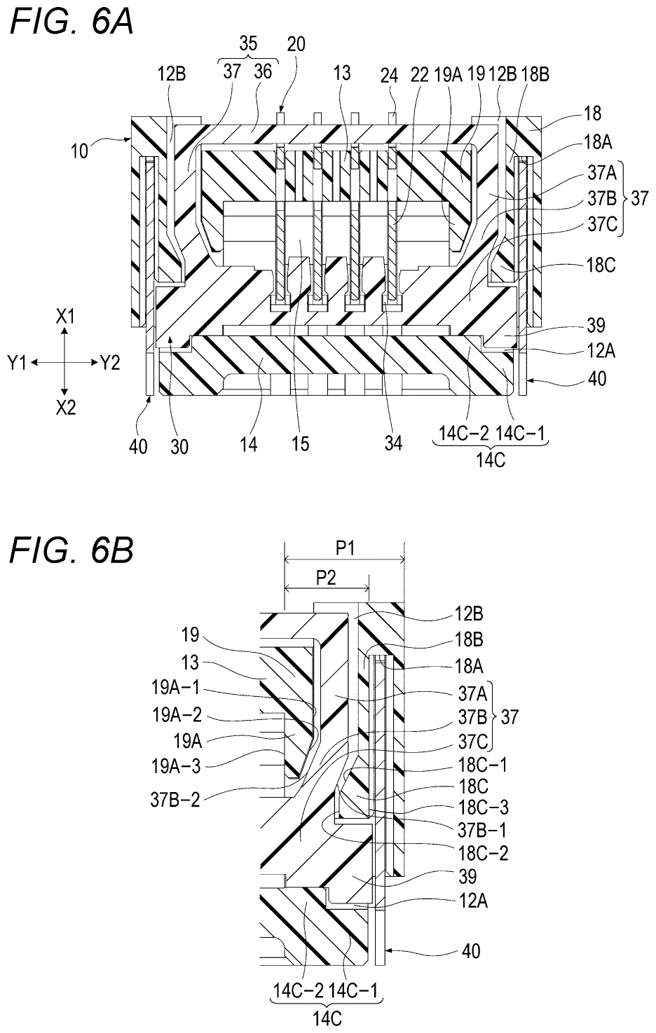

As illustrated in FIG. 4A, each side part 12 has an overhang part 17 that overhangs outward in the connector width direction from the side end of the lower wall 11, a metal fitting holding part 18 that stands from the upper surface of the overhang part 17, and an end wall part 19. In addition, at the rear of each side part 12, a shaft housing portion 12A that houses an outer shaft part 39 of the movable member 30 is formed in a concave shape that opens upward, as illustrated in FIG. 4A and FIG. 4B. In addition, in each side part 12, a space formed in the range other than the shaft housing portion 12A, the metal fitting holding part 18, and the end wall part 19 as viewed from above forms a side housing part 12B that houses a side reinforcement portion 37 of the movable member 30 in the closed position (see FIGS. 6A and 6B). The side housing part 12B is in communication with the shaft housing portion 12A.

As illustrated in FIG. 4A, each overhang part 17 forms the shape of a plate having a plate surface perpendicular to the up-down direction, and the front side of the overhang part 17 extends forward beyond the front wall 13. As illustrated in FIG. 4B, at the rear side of the overhang part 17, a portion forming the lower inner wall surface of the shaft housing portion 12A constitutes an outer shaft support portion 17A that can support the outer shaft part 39 from below.

As illustrated in FIG. 4A, each metal fitting holding part 18 stands upward from approximately half the outside of the overhang part 17 in the connector width direction, extends in the front-back direction, and has its front end at the same position as the front end of the overhang part 17. The metal fitting holding part 18 forms the shape of a plate with a plate surface perpendicular to the connector width direction. A metal fitting housing portion 18A for housing a portion of the metal fitting 40 is formed at the middle of the metal fitting holding part 18 in the connector width direction. The metal fitting housing portion 18A forms the shape of a groove that spreads perpendicular to the connector width direction and extends in the front-back direction.

As illustrated in FIGS. 4A and 4B, each metal fitting holding part 18 has an inner portion 18B inside of the metal fitting housing portion 18A in the connector width direction. The inner portion 18B is located in a range overlapping with the shaft housing portion 12A in the connector width direction, and is provided in front of the shaft housing portion 12A. The rear side of the inner portion 18B of the metal fitting holding part 18 forms a front restriction portion 18C as a shaft restriction portion that restricts the forward movement of the outer shaft part 39 of the movable member 30. The rear end surface of the front restriction portion 18C is a flat surface perpendicular to the front-back direction, and forms the front inner wall surface of the shaft housing portion 12A. The rear end surface of the front restriction portion 18C abuts against the outer shaft part 39 of the movable member 30 to restrict the forward movement of the outer shaft part 39.

As illustrated in FIG. 6B, each front restriction portion 18C has, as inner surfaces in the connector width direction, a front inner surface 18C-1, which is the inner surface of the front portion, and a rear inner surface 18C-2, which is the inner surface of the rear portion. When viewed in the up-down direction, the front inner surface 18C-1 extends so as to incline inward in the connector width direction (toward the Y1 side in FIG. 6B) as it approaches the rear side. When viewed in the up-down direction, the rear inner surface 18C-2 extends parallel to the front-back direction. Therefore, as illustrated in FIG. 6B, the front restriction portion 18C protrudes inward in the connector width direction more than the other portion (the portion located in front of the front restriction portion 18C) in the inner portion 18B of the metal fitting holding part 18. Also, as illustrated in FIG. 6B, the outer surface 18C-3 of the front restriction portion 18C extends entirely parallel to the front-back direction and forms a portion of the inner surface of the groove of the metal fitting housing portion 18A. The front restriction portion 18C with such a shape is larger, that is, is formed to be thicker in the connector width direction than the other portions described above.

As illustrated in FIG. 4A, each end wall part 19 rises upward from the inner portion in the connector width direction at the front of the overhang part 17, extends in the front-back direction, and its front end at the same position as the front end of the front wall 13. The end wall part 19 is located more inward than metal fitting holding part 18 in the connector width direction, with a clearance from the metal fitting holding part 18. The space formed between the end wall part 19 and the metal fitting holding part 18 forms the front of the side housing part 12B.

The front of each end wall part 19 is connected to the end of the front wall 13 in the connector width direction. The rear of each end wall part 19 extends further rearward than the front wall 13, thereby forming a flat conductor restriction portion 19A that restricts the movement of the flat conductor C in the connector width direction. As illustrated in FIG. 6B, the flat conductor restriction portion 19A has, as outer surfaces in the connector width direction, a front outer surface 19A-1, which is the outer surface of the front, and a rear outer surface 19A-2, which is the outer surface of the rear. The front outer surface 19A-1 extends parallel to the front-back direction when viewed in the up-down direction. The rear outer surface 19A-2 extends so as to incline outward (toward a Y2 side in FIG. 6B) in the connector width direction as it approaches the front side when viewed in the up-down direction. In addition, the flat conductor restriction portion 19A includes an inner surface 19A-3 extending entirely parallel to the front-back direction as illustrated in FIG. 6B. The inner surface 19A-3 is a flat surface perpendicular to the connector width direction, and contacts the ear part C3 of the flat conductor C to restrict movement of the flat conductor C in the connector width direction.

When the movable member 30 is in the closed position, the side reinforcement portion 37 of the movable member 30 is disposed between the front restriction portion 18C and the flat conductor restriction portion 19A. Details of the positional relationship among the front restriction portion 18C, the flat conductor restriction portion 19A, and the side reinforcement portion 37 will be described later with reference to FIGS. 6A and 6B.

As illustrated in FIG. 4A, the front wall 13 protrudes upward relative to the bottom wall 11, and extends over the same range as the bottom wall 11 in the connector width direction. The front wall 13 has a groove-shaped front housing part 13A recessed from the upper surface of the front wall 13, at the same position as the lower housing part 16 in the connector width direction. As illustrated in FIGS. 5A and 5B, the front housing part 13A is adapted to house a portion of the upper arm part 22 of each terminal 20.

As illustrated in FIG. 4A, the introduction part 14 has a lower introduction wall portion 14A that forms the rear portion of the bottom wall 11, an upper introduction wall portion 14B that extends in the connector width direction above the lower introduction wall portion 14A, and a pair of side introduction wall portions 14C that extends in the up-down direction and couples the ends of the lower introduction wall portion 14A and the upper introduction wall portion 14B. The space surrounded by the lower introduction wall portion 14A, the upper introduction wall portion 14B, and the side introduction wall portions 14C and penetrating in the front-back direction forms an introduction port 14D (a portion of the receiving portion 15) for introducing the flat conductor C into the back of the receiving portion 15.

The outer portion 14C-1 of each side introduction wall portion 14C is located in a range overlapping with the shaft housing portion 12A in the connector width direction. The front end surface of the outer portion 14C-1 is a flat surface perpendicular to the front-back direction, and forms the rear inner wall surface of the shaft housing portion 12A. The inner portion of the side introduction wall portion 14C is located more inward than the shaft housing portion 12A in the connector width direction. The inner portion of the side introduction wall portion 14C forms a rear restriction portion 14C-2 that restricts the rearward movement of the movable member 30. The rear restriction portion 14C-2 restricts the rearward movement of the movable member 30 by abutting the movable member 30 with its front end surface.

Each terminal 20 is made by punching a metal plate member, and is press-fitted and attached from the front into the housing 10 with the plate surface perpendicular to the connector width direction (see FIG. 3). As illustrated in FIGS. 5A and 5B, each terminal 20 has the lower arm part 21 extending along the front-back direction below the receiving portion 15, the upper arm part 22 extending along the front-back direction above the receiving portion 15, the coupling arm part 23 extending in the up-down direction forward of the front wall 13 and coupling the front ends of the lower arm part 21 and the upper arm part 22, and a connection part 24 extending forward and downward from a lower portion of the coupling arm part 23. The lower arm part 21 and the upper arm part 22 extend from the front to the rear along the front-back direction of the housing 10 (connector 1).

As illustrated in FIGS. 5A and 5B, each lower arm part 21 has a retained portion 21A provided at the front end and a lower elastic portion 21B extending rearward from the retained portion 21A. The retained portion 21A is press-fitted into the front end of the lower housing part 16, that is, the groove portion penetrating the front wall 13. The lower elastic portion 21B extends so as to incline upward as it approaches the rear side while being partially housed in the lower housing part 16, and is elastically displaceable in the up-down direction. The gap between the lower elastic portion 21B and the groove bottom surface of the lower housing part 16 becomes larger toward the rear, and this gap allows the lower elastic portion 21B to be elastically displaced.

Each lower elastic portion 21B has a pressing portion 21B-1 that protrudes upward at the rear end. As illustrated in FIGS. 5A and 5B, when the lower elastic portion 21B is in a free state, the pressing portion 21B-1 protrudes from the lower housing part 16 and is located within the receiving portion 15. When the flat conductor C is connected to the connector 1, the pressing portion 21B-1 presses the lower surface of the flat conductor C from below (see FIG. 10A).

Each upper arm part 22 is elastically displaceable in the up-down direction, and has an upper elastic portion 22A extending rearward from the position of connection with the connecting arm part 23, and an extension portion 22B extending rearward from the rear end of the upper elastic portion 22A, as illustrated in FIGS. 5A and 5B. The upper elastic portion 22A extends so as to incline downward as it approaches the rear side. The upper elastic portion 22A has a contact portion 22A-1 at the rear end that protrudes downward at approximately the same position as the pressing portion 21B-1 in the front-back direction. When the upper elastic portion 22A is in a free state, the contact portion 22A-1 is located within the receiving portion 15. When the flat conductor C is connected to the connector 1, the contact portion 22A-1 and the pressing portion 21B-1 sandwiches the flat conductor C therebetween in the up-down direction, and the contact portion 22A-1 contacts the circuit part C1 of the flat conductor C from above (see FIG. 10A). When the contact portion 22A-1 contacts with the circuit part Cl in this manner, the flat conductor C and the terminal 20 can be brought into electrical conduction.

Each extension portion 22B extends upward and rearward from the rear end of the upper elastic portion 22A, and is housed in a groove 34 of the movable member 30. The rear of the extension portion 22B forms an inner shaft support portion 22B-1 that can support an inner shaft part 31A of the movable member 30 from above. The inner shaft support portion 22B-1 is located rearward of the rear end of the lower arm part 21, and extends straight in the front-back direction. As illustrated in FIG. 5A, the inner shaft support portion 22B-1 supports the inner shaft part 31A of the movable member 30 from above when the movable member 30 is in the closed position.

As illustrated in FIGS. 5A and 5B, the connection part 24 is located forward of the front wall 13. The lower edge of the connection part 24 is located slightly below the lower surface of the lower wall 11 of the housing 10. When the connector 1 is placed on the mounting surface of a circuit board (not illustrated), the connection part 24 is soldered to a corresponding circuit part (pad) on the mounting surface.

As illustrated in FIGS. 1 to 3, the movable member 30 has a main body 31 extending over the range between the metal fitting holding parts 18 in the connector width direction, and two outer shaft parts 39 as shaft parts provided on the side ends of the main body 31 in the connector width direction. The movable member 30 is movable between the closed position and the open position by rotating about a rotation axis extending in the connector width direction.

When the movable member 30 is in the closed position, the main body 31 covers the receiving portion 15 of the housing 10 from above in the Z-axis direction.

In the present embodiment, the movable member 30 “being in the closed position” means that the movable member 30 is located in the closed position, and when the movable member 30 “being in the open position” means that the movable member 30 is located in the open position.

FIG. 3 illustrates the movable member 30 in the same posture as when it is in the open position. As illustrated in FIG. 3, the main body 31 has a plate-like cover plate part 32 that is substantially rectangular when viewed in the plate thickness direction (X-axis direction) of the main body 31, a reinforcement portion 35 that protrudes from the front surface of the cover plate part 32 (the lower surface when in the closed position) and extends along the edge of the cover plate part 32, and the locking parts 38 that protrude from the front surface of the cover plate part 32 (the lower surface when in the closed position).

As illustrated in FIG. 3, the cover plate part 32 has upper housing parts 33 arranged in the connector width direction for housing the upper arm parts 22 of the terminals 20 (see also FIG. 5A). The upper housing parts 33 are recessed from the front surface of the cover plate 32 (the lower surface when in the closed position) and extend in the up-down direction (the front-back direction when in the closed position). A groove 34 is formed at the lower portion of the groove 34 in the open position (the rear portion when in the closed position) that penetrates the cover plate part 32 in the front-back direction (the up-down direction when in the closed position). Adjacent grooves 34 are separated by partition walls 31B.

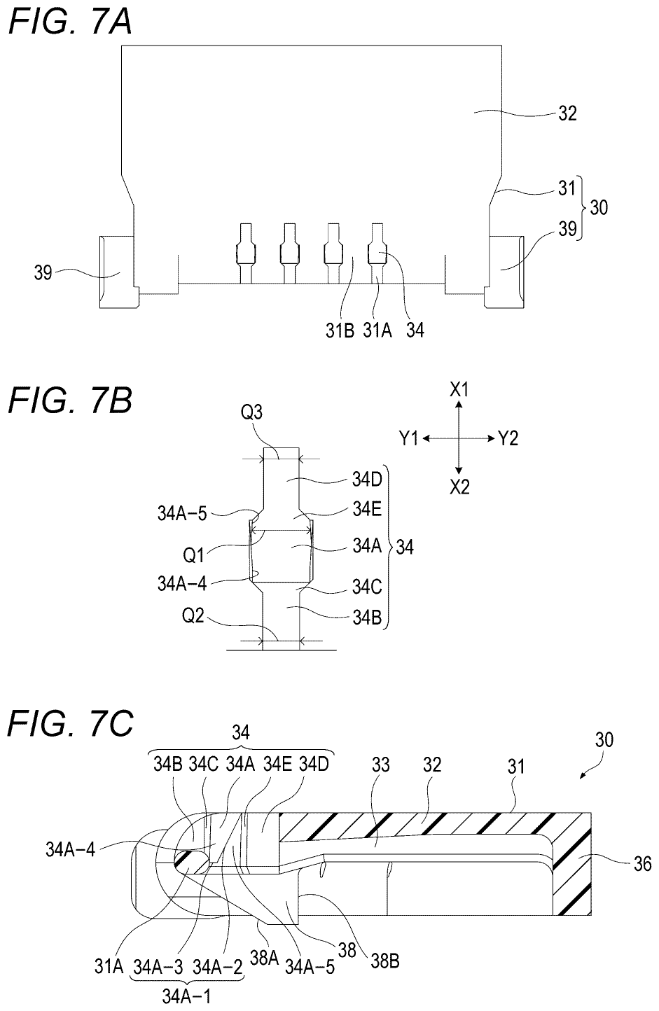

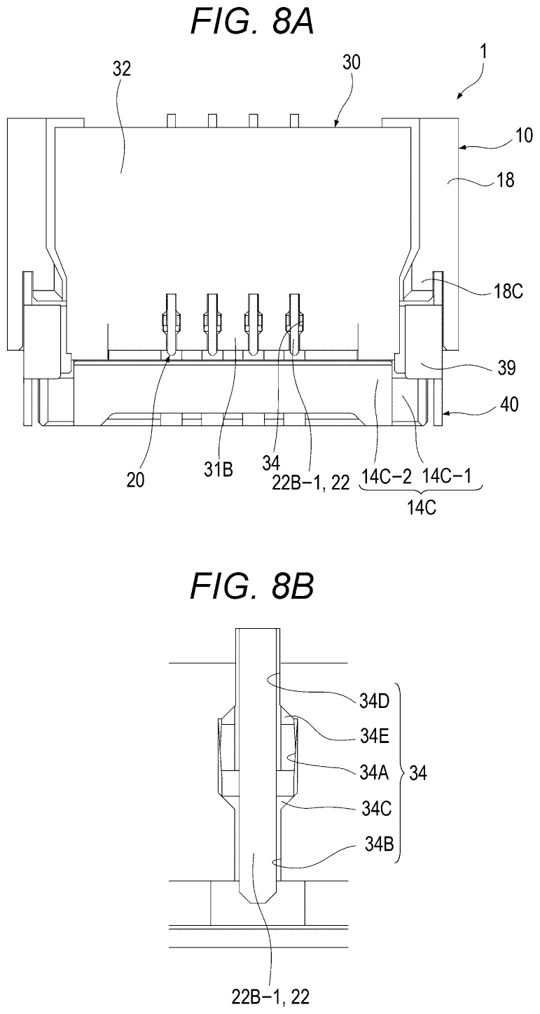

As illustrated in FIGS. 7A to 7C, each groove 34 has a wide portion 34A formed in the middle in the front-back direction, a first narrow portion 34B and a first transition portion 34C formed rearward of the wide portion 34A, and a second narrow portion 34D and a second transition portion 34E formed forward of the wide portion 34A. The groove width dimensions (dimensions in the connector width direction) of the wide portion 34A, first narrow portion 34B, first transition portion 34C, second narrow portion 34D, and second transition portion 34E are larger than the plate thickness dimension (dimension in the connector width direction) of the terminal 20 (see FIGS. 8A and 8B).

As illustrated in FIG. 7B, each wide portion 34A is formed to have the widest groove width in the groove 34. A groove width dimension Q1 of the wide portion 34A is the distance between opposing groove inner surfaces in the groove width direction at any position in the wide portion 34A, and the position represented as “Q1” in FIG. 7B is merely one example.

As illustrated in FIG. 7C, a parting line 34A-1 is formed on the inner surface of the groove in the wide portion 34A during molding of the movable member 30. The parting line 34A-1 is a stepped line formed during molding of the movable member 30 along a mating surface between one mold (not illustrated) placed from one side in the thickness direction of the movable member 30 (the up-down direction in FIG. 7C) and the other mold (not illustrated) placed from the other side.

The parting line 34A-1 includes an inclined line 34A-2 that constitutes the most part of the parting line 34A-1, and a parallel line 34A-3 that constitutes the remaining part. As illustrated in FIG. 7C, the inclined line 34A-2 extends in a range from the upper end position of the movable member 30 to a position near the lower end thereof, while inclining with respect to the up-down direction, as viewed in the connector width direction. Specifically, the inclined line 34A-2 inclines linearly rearward as it extends downward in FIG. 7C. The parallel line 34A-3 forms a straight line parallel to the front-back direction, and extends rearward from the lower end position of the inclined line 34A-2 to the boundary position with the first transition portion 34C.

In the present embodiment, the groove inner surface of the wide portion 34A is divided by the parting line 34A-1 into two surfaces, that is, a first surface 34A-4 located above the parting line 34A-1 and a second surface 34A-5 located below the parting line 34A-1. The first surface 34A-4 and the second surface 34A-5 are formed as inclined surfaces with different inclination directions. Specifically, as illustrated in FIG. 7B, the first surface 34A-4 has an inclined portion that inclines inward in the groove width direction (Y-axis direction) as it approaches the rear side when the movable member 30 in the closed position is viewed in the up-down direction (Z-axis direction perpendicular to the plane of paper), and inclines inward in the groove width direction (Y-axis direction) when the movable member 30 in the closed position is viewed in the front-back direction (X-axis direction). As illustrated in FIG. 7B, the second surface 34A-5 has an inclined portion that inclines inward in the groove width direction as it approaches the front side when the movable member 30 in the closed position is viewed in the up-down direction (see FIG. 7B), and inclines inward in the groove width direction as it approaches the upper side when the movable member 30 in the closed position is viewed in the front-back direction.

In the present embodiment, the parting line 34A-1 is formed on the groove inner surface of the wide portion 34A, which has the widest groove width in the groove 34. That is, during molding of the movable member 30, the mating surface between one mold (not illustrated) and the other mold (not illustrated) at the position corresponding to the groove 34 is located within the wide portion 34A. Therefore, the width dimension (dimension in the connector width direction) of the portion corresponding to the wide portion 34A in both molds can be increased, and as a result, sufficient strength of the portion can be ensured. In addition, in the present embodiment, the mating surface between the one mold and the other mold has an inclined surface along the inclined line 34A-2 and a parallel surface along the parallel line 34A-3. Therefore, when each mold is moved in the thickness direction of the movable member 30, there is no portion on the mating surface where the molds rub against each other. This favorably avoids damage due to wear of both molds.

In the present embodiment, the parting line 34A-1 has both the inclined line 34A-2 and the parallel line 34A-3, but the shape of the parting line is not limited to this and various modifications are possible. As a modified example, the parting line may have only an inclined line or only a parallel line.

The first narrow portion 34B is narrower in groove width than the wide portion 34A. That is, as illustrated in FIG. 7B, a groove width dimension Q2 of the first narrow portion 34B is smaller than a groove width dimension Q1 of the wide portion 34A. The opposing groove inner surfaces of the first narrow portion 34B are flat surfaces perpendicular to the groove width direction (Y-axis direction). As illustrated in FIG. 7C, the groove inner surfaces of the first narrow portion 34B are coupled to each other at the rear and lower side when in the closed position by the inner shaft part 31A having an oval cross section perpendicular to the groove width direction.

As illustrated in FIG. 7B, the first transitional portion 34C is located between the wide portion 34A and the first narrow portion 34B, and couples the wide portion 34A and the first narrow portion 34B. The first transitional portion 34C forms a flat surface that inclines inward in the groove width direction as it approaches the rear side. That is, the groove width of the first transitional portion 34C narrows from the wide portion 34A toward the first narrow portion 34B.

The second narrow portion 34D is narrower in groove width than the wide portion 34A and has the same groove width as the first narrow portion 34B. That is, as illustrated in FIG. 7B, a groove width dimension Q3 of the first narrow portion 34B is smaller than the groove width dimension Q1 of the wide portion 34A and equal to the groove width dimension Q2 of the first narrow portion 34B. The opposing groove inner surfaces of the second narrow portion 34D are flat surfaces perpendicular to the groove width direction (Y-axis direction).

As illustrated in FIG. 7B, the second transition portion 34E is located between the wide portion 34A and the second narrow portion 34D, and couples the wide portion 34A and the second narrow portion 34D. The second transition portion 34E forms a flat surface that inclines inward in the groove width direction as it approaches the front side. That is, the groove width of the second transition portion 34E narrows from the wide portion 34A to the second narrow portion 34D.

In the present embodiment, the first transition portion 34C is provided between the wide portion 34A and the first narrow portion 34B, and the second transition portion 34E is provided between the wide portion 34A and the second narrow portion 34D. Accordingly, the groove inner surface between the wide portion 34A and the first narrow portion 34B, and the groove inner surface between the wide portion 34A and the second narrow portion 34D are formed as smooth surfaces without corners. Therefore, when the extension portion 22B of the terminal 20 is inserted into the wide portion 34A during assembly of the connector, and when the movable member 30 is moved between the open position and the closed position during use of the connector 1, the extension portion 22B is less likely to interfere with the groove inner surfaces of the groove portion 34. This effectively avoids damage to the movable member 30 and the terminal 20. In addition, the first transition portion 34C and the second transition portion 34E have groove inner surfaces that are flat inclined surfaces. Therefore, the portions of the mold corresponding to the first transition portion 34C and the second transition portion 34E can be simplified in shape, which makes it easier to manufacture the mold.

As illustrated in FIGS. 3, 6A and 6B, the reinforcement portion 35 has a front reinforcement portion 36 that extends along the front edge of the cover plate part 32 in the closed position, and two side reinforcement portions 37 that extend along the side edges (edges located at both ends in the connector width direction) of the movable member 30. The front reinforcement portion 36 extends linearly over the entire range of the cover plate part 32 in the connector width direction. As illustrated in FIGS. 5A and 6A, when the movable member 30 is in the closed position, the front reinforcement portion 36 covers the front wall 13 and the coupling arm part 23 from the front, above the connection part 24.

As illustrated in FIGS. 6A and 6B, when in the closed position, the side reinforcement portions 37 extend in the front-back direction from the position of coupling with the front reinforcement portion 36 to the rear end of the cover plate part 32 (see also FIG. 3). Further, when in the closed position, the side reinforcement portions 37 protrude downward, that is, toward the receiving portion 15 of the housing 10.

As illustrated in FIGS. 6A and 6B, each side reinforcement portion 37 has a front parallel portion 37A that forms the front portion in the closed position, an inclined portion 37B that forms the middle portion, and a rear parallel portion 37C that forms the rear portion (see also FIG. 3). The front parallel portion 37A and the rear parallel portion 37C extend parallel to the front-back direction in the closed position. The inclined portion 37B extends at an inward inclination in the connector width direction as it extends rearward in the closed position. As illustrated in FIGS. 6A and 6B, when the movable member 30 is in the closed position, the side reinforcement portion 37 is accommodated in the side housing portion 12B of the housing 10.

In the present embodiment, as described above, the inclined portion 37B of each side reinforcement portion 37 extends inwardly in the connector width direction. That is, the thickness direction of the inclined portion 37B is inclined with respect to the connector width direction. Therefore, in the case of increasing the thickness dimension (dimension in the thickness direction) of the inclined portion 37B to improve the strength of the side reinforcement portion 37, the increase in the dimension of the inclined portion 37B in the connector width direction is smaller than in a case where the inclined portion 37B is not provided and the thickness direction of the entire side reinforcement portion 37 aligns with the connector width direction. Accordingly, the movable member 30 and the connector 1 are less likely to become large in the connector width direction.

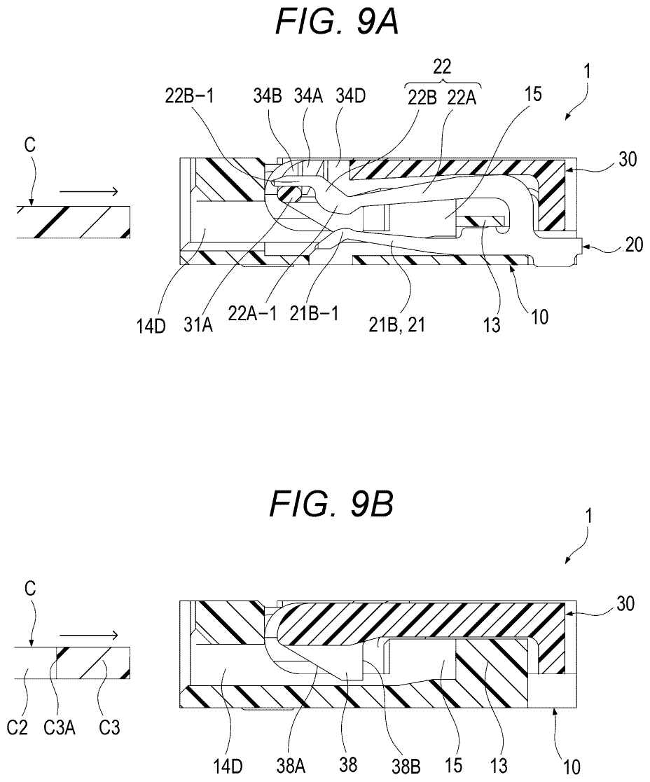

As illustrated in FIG. 7C, each locking part 38 is provided to protrude from the lower surface of the rear portion of the cover plate part 32 in the closed position (the front surface of the lower portion of the cover plate part 32 in the open position) at a position corresponding to the locked portion C3A (see FIG. 1) of the flat conductor C in the connector width direction. In the closed position, the locking part 38 is located within the receiving portion 15 (see FIG. 9B), and is located so as to be able to lock the locked portion C3A of the flat conductor C from the rear when the flat conductor C is inserted into the receiving portion 15 (see FIG. 10B).

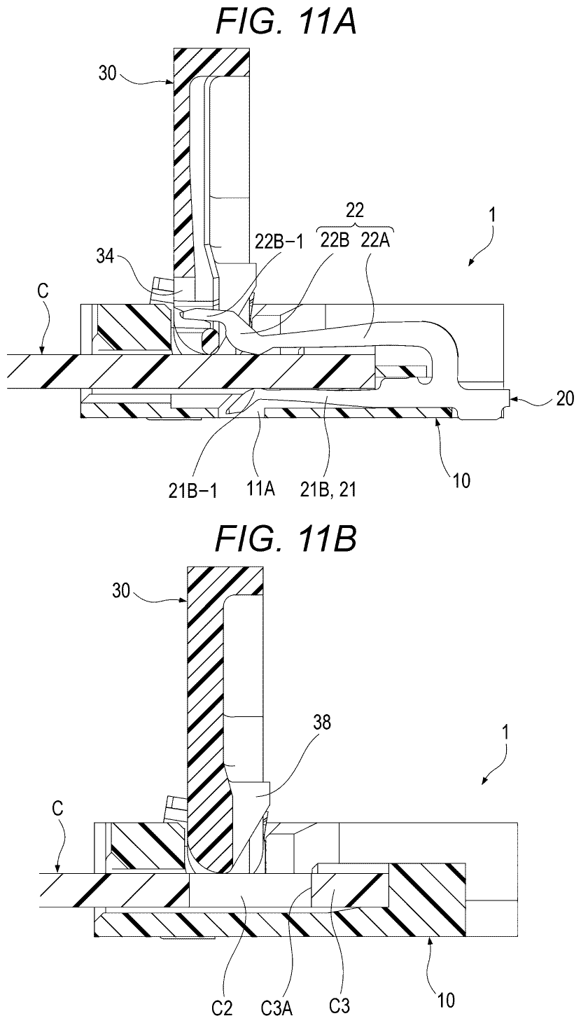

Each locking part 38 has a guide surface 38A on its rear surface that is inclined downward as it approaches the front side, and a locking surface 38B on its front surface that locks from the rear the locked portion C3A of the flat conductor C. When the movable member 30 is in the open position, the locking part 38 is positioned outside the housing 10, and is released from the state of locking the locked portion C3A of the flat conductor C (see FIG. 11B).

Each outer shaft part 39 protrudes outward in the connector width direction from the outer surface of the rear parallel portion 37C at the rear in the closed position, and is housed in the shaft housing portion 12A of the housing 10 (see also FIGS. 3 and 4B). The outer shaft part 39 has a substantially rectangular cross-sectional shape perpendicular to the connector width direction, and is oriented such that the longitudinal direction is the front-back direction in the closed position and the longitudinal direction is the up-down direction in the open position. The outer shaft part 39 is supported from below by the outer shaft support portion 17A of the housing 10 regardless of the position of the movable member 30. The outer shaft part 39 also functions as a cam portion that lifts a biasing piece 42A (described later) of the metal fitting 40 from below during the movement from the closed position to the open position and when in the open position.

Each metal fitting 40 is made by punching out a metal plate member and bending a portion of the punched member in the plate thickness direction. As illustrated in FIG. 3, the metal fitting 40 has a fixed arm part 41 that is straight and extends in the front-back direction, a biasing arm part 42 that extends in the front-back direction above the fixed arm part 41, a coupling part 43 that couples front ends of the fixed arm part 41 and the biasing arm part 42, and a fitting part 44 that is fitted into the housing 10 from the rear. The metal fitting 40 is held by the metal fitting holding part 18 when a press-fitting fixing portion 41A at the front end of the fixed arm part 41 is press-fitted into the front end of the metal fitting housing portion 18A of the housing 10 from the rear.

Each metal fitting 40 has a plate surface, most of which is perpendicular to the connector width direction, and is located outside of the outer shaft part 39 of the movable member 30 in the connector width direction, and is adjacent to the outer shaft part 39. In the metal fitting 40, only the biasing piece 42A described later is formed by being bent in the connector width direction. Therefore, the entire metal fitting 40 is made compact with a simple shape.

Each fixed arm part 41 is fixed to the housing 10 while being supported by the groove bottom surface of the metal fitting housing portion 18A. The biasing arm part 42 is elastically displaceable in the up-down direction, and has the biasing piece 42A at its rear end for biasing the outer shaft part 39 of the movable member 30 from above. The biasing piece 42A is bent at the upper edge of the rear end of the biasing arm part 42 and extends inward in the connector width direction, that is, toward the outer shaft part 39 of the movable member 30.

Each biasing piece 42A has a plate surface (rolled surface) perpendicular to the up-down direction, and is located directly above the outer shaft part 39. The lower surface of the biasing piece 42A comes into contact with the upper surface of the outer shaft part 39, and is capable of restricting the upward movement of the outer shaft part 39 and the movable member 30. Since the biasing arm part 42 is not elastically displaced in the closed position, the biasing piece 42A does not bias the outer shaft part 39. However, since the biasing arm part 42 is elastically displaced upward in the open position, the biasing piece 42A biases the outer shaft part 39 from above.

Each fitting part 44 is provided at a position in a range overlapping with the biasing piece 42A in the front-back direction. The fitting part 44 extends downward from the lower edge of the fixed arm part 41 and then extends forward, forming an overall L-shape. As illustrated in FIG. 1, the fitting part 44 fits into the rear end of the overhang part 17 from behind, and thereby locking the rear end of the overhang part 17 from below. In the present embodiment, the fitting part 44 also functions as a fixed portion that is fixed to a corresponding portion (not illustrated) on the mounting surface of the circuit board by solder connection.

The connector 1 having such a configuration is assembled as follows. First, the movable member 30, which is held in the open position, is attached to the housing 10 from above. Specifically, the lower end of the main body 31 in the open position is placed in the space between the lower housing part 16 and the introduction part 14 of the housing 10 in the front-back direction. At the same time, the outer shaft part 39 is placed in the shaft housing portion 12A of the housing 10.

Next, while the movable member 30 is maintained in the open position, the lower arm part 21 of the terminal 20 is press-fitted from the front to the rear into the lower housing part 16 of the housing 10, thereby attaching the terminal 20 to the housing 10. At this time, the upper edge of the retained portion 21A of the lower arm part 21 bites into the groove inner surface of the front end of the lower housing part 16, thereby retaining the retained portion 21A (see FIGS. 5A and 5B).

When each terminal 20 is attached to the housing 10, the rear end portion of the upper arm part 22, specifically the inner shaft support portion 22B-1 is inserted from the front into the wide portion 34A of the groove 34 of the movable member 30. Thus, in the present embodiment, the inner shaft support portion 22B-1 is inserted into the wide portion 34A of the groove 34, which has the widest groove width. Therefore, even if the relative positions of the movable member 30 and the terminal 20 is slightly misaligned in the connector width direction immediately before the insertion of the inner shaft support portion 22B-1, the inner shaft support portion 22B-1 can be easily inserted into the wide portion 34A, making it easy to assemble the connector 1. Furthermore, since it is possible to effectively avoid the inner shaft support portion 22B-1 from colliding with the partition wall 31B of the movable member 30 when the terminal 20 is attached, the upper arm part 22 of the terminal 20 can be suppressed from becoming damaged due to buckling or the like.

When is inserted into the wide portion 34A, the inner shaft support portion 22B-1 is positioned directly above the inner shaft part 31A and is capable of supporting the inner shaft part 31A from above (see FIG. 5B). Since the inner shaft support portion 22B-1 is capable of supporting the inner shaft part 31A in this manner, the upward movement of the inner shaft part 31A and the movable member 30 is restricted.

In the present embodiment, the posture of the movable member 30 with the inner shaft support portion 22B-1 inserted into the wide portion 34A is described as the posture of the movable member 30 in the open position. However, the position of the movable member 30 with the inner shaft support portion 22B-1 inserted can be changed as appropriate. As a modified example, the position of the movable member 30 with the inner shaft support portion 22B-1 inserted may be a predetermined rotational position between the closed position and the open position. That is, the position of the movable member 30 with the inner shaft support portion 22B-1 inserted may be a predetermined position different from the closed position. In that case, the wide portion 34A of the movable member 30 is formed in a shape that extends in the front-back direction when the movable member 30 is in the above-mentioned predetermined position.

Next, the metal fitting 40 is attached from the rear to each metal fitting housing portion 18A of the housing 10. Specifically, the press-fitting fixing portion 41A is press-fitted into the front end of the metal fitting housing portion 18A, and the fitting part 44 is fitted into the rear end of the overhang part 17. As a result, the biasing piece 42A of the metal fitting 40 is positioned directly above the outer shaft part 39, thereby restricting the outer shaft part 39 from moving upward. By attaching the terminals 20, the movable member 30, and the metal fittings 40 to the housing 10 in this manner, the connector 1 is completed.

In the present embodiment, the terminals 20 are attached to the housing 10 before the metal fittings 40. However, the order of attachment of the terminals 20 and the metal fittings 40 is not limited to this. For example, the metal fittings 40 may be attached first, or the terminals 20 and the metal fittings 40 may be attached simultaneously.

Immediately before use of the connector 1, that is, immediately before connection of the flat conductor C, the movable member 30 is placed in the closed position. When the movable member 30 is in the closed position, as illustrated in FIG. 5A, the rear end portion of the upper arm part 22, specifically the extension portion 22B of the terminal 20 is housed in the groove 34 of the movable member 30. At this time, the extension portion 22B extends over almost the entire range of the groove 34 in the front-back direction, and its displacement in the groove width direction (connector width direction) is restricted by the inner wall surfaces of the first narrow portion 34B and the second narrow portion 34D, which have the narrowest groove widths in the groove 34.

In the present embodiment, in the groove 34 of the movable member 30 in the closed position, the first narrow portion 34B and the second narrow portion 34D, which have the narrowest groove widths, restrict displacement of the extension portion 22B of the upper arm part 22 in the connector width direction. Therefore, the position of the upper arm part 22 of the terminal 20 and the position of the contact portion 22A-1 are stabilized, and the contact state between the terminal 20 and the flat conductor C is favorably maintained.

In the present embodiment, provided on both sides of the wide portion 34A in the front-back direction are portions of which the groove width is narrower than that of the wide portion 34A. Specifically, the first narrow portion 34B is provided behind the wide portion 34A, and the second narrow portion 34D is provided in front of the wide portion 34A, so that the displacement of the extension portion 22B of the upper arm part 22 is more favorably restricted. Therefore, the position of the contact portion 22A-1 of the terminal 20 is more stabilized, so that the contact state between the terminal 20 and the flat conductor C is more favorably maintained.

Moreover, when the flat conductor C is not connected to the connector 1, the upper arm part 22 is in a free state. In the present embodiment, when the upper arm part 22 is in a free state, the opposing area between the extension portion 22B and the groove inner surface of the first narrow portion 34B is larger than the opposing area between the extension portion 22B and the groove inner surface of the second narrow portion 34D as illustrated in FIG. 5A. That is, the displacement of the extension portion 22B in the groove width direction is restricted mainly by the groove inner surface of the first narrow portion 34B.

On the other hand, when the flat conductor C is connected to the connector 1, the upper arm part 22 is in an upward elastically displaced state. In the present embodiment, when the upper arm part 22 is in an elastically displaced state, the opposing area between the extension portion 22B and the groove inner surface of the second narrow portion 34D is larger than the opposing area between the extension portion 22B and the first narrow portion 34B (see FIG. 10A). In other words, the displacement of the extension portion 22B in the groove width direction is restricted mainly by the groove inner surface of the second narrow portion 34D.

As illustrated in FIGS. 6A and 6B, when the movable member 30 is in the closed position, the side reinforcement portion 37 of the movable member 30 is housed in the side housing portion 12B of the housing 10. At this time, as illustrated in FIG. 6B, the inner portion 18B of the metal fitting holding part 18, the end wall part 19, and the side reinforcement portion 37 are located adjacent to each other within a predetermined range P2 that is a part of the range Pl of the side part 12 in the connector width direction. In addition, the front of the forward restriction portion 18C of the inner portion 18B, the rear of the flat conductor restriction portion 19A of the end wall part 19, and the inclined portion 37B of the side reinforcement portion 37 are located with an overlapping area in the front-back direction.

As illustrated in FIG. 6B, the front inner surface 18C-1 of the front of the front restriction portion 18C extends along the outer surface 37B-1 of the inclined portion 37B. That is, the front restriction portion 18C and the inclined portion 37B are located with an overlapping area in the connector width direction. Since the front inner surface 18C-1 extends at an inward inclination in the connector width direction as it approaches the rear, the wall thickness dimension (dimension in the connector width direction) of the front of the front restriction portion 18C becomes large, which improves the strength of the front of the front restriction portion 18C. As a result, the forward movement of the outer shaft part 39 and the movable member 30 can be favorably restricted by the front restriction portion 18C.

In the present embodiment, the rear of the front restriction portion 18C is formed to have the same dimension as the maximum thickness dimension at the front of the front restriction portion 18C, that is, the thickness dimension at the rear end of the front of the front restriction portion 18C over the entire range in the front-back direction. Therefore, of the front restriction portion 18C, the portion with the maximum thickness dimension can be formed large in the front-back direction, so that the strength of the front restriction portion 18C can be further improved.

As illustrated in FIG. 6B, the rear outer surface 19A-2 of the rear of the flat conductor restriction portion 19A extends along the inner surface 37B-2 of the inclined portion 37B. That is, the flat conductor restriction portion 19A and the inclined portion 37B are located with an overlapping area in the connector width direction. Since the rear outer surface 19A-2 extends with an inclination toward the outside in the connector width direction as it approaches the front, the thickness dimension (dimension in the connector width direction) of the rear of the flat conductor restriction portion 19A becomes larger, so that the strength of the rear of the flat conductor restriction portion 19A is improved. As a result, the movement of the flat conductor C in the connector width direction can be favorably restricted by the flat conductor restriction portion 19A.

In this manner, in the present embodiment, the inner portion 18B of the metal fitting holding part 18, the end wall part 19, and the side reinforcement portion 37 are adjacent to each other within the predetermined range P2 in the connector width direction. In addition, they are located with an area where the front restriction portion 18C and the inclined portion 37B overlap, and are located with an area where the flat conductor restriction portion 19A and the inclined portion 37B overlap. Therefore, even if the thickness dimensions of the front restriction portion 18C, the flat conductor restriction portion 19A, and the inclined portion 37B are increased to improve the strength, it is possible to suppress increase in the areas occupied by them in the connector width direction. As a result, the upsizing of the connector 1 in the connector width direction can be minimized.

Next, the operation of inserting and removing the flat conductor C into and from the connector 1 will be described.

First, the connection parts 24 of the terminals 20 of the connector 1 are soldered to corresponding circuit parts of a circuit board (not illustrated), and the fitting parts 44 of the metal fittings 40 are soldered to corresponding parts of the circuit board. When the connection parts 24 and the fitting parts 44 are soldered, the connector 1 is attached to the circuit board.

If the movable member 30 is not in the closed position when the connector 1 is attached to the circuit board, the movable member 30 is brought into the closed position. In the closed position, the outer shaft parts 39 of the movable member 30 are in a posture extending in the front-back direction within the shaft housing portions 12A of the housing 10. Therefore, the biasing arm parts 42 of the metal fittings 40 are not elastically displaced, and no biasing force based on the elastic force of the biasing arm parts 42 acts on the outer shaft parts 39.

As illustrated in FIGS. 9A and 9B, the flat conductor C is positioned so as to extend in the front-back direction (X-axis direction) along the mounting surface (not illustrated) of the circuit board at the rear of the connector 1 (see also FIG. 1). Then, the flat conductor C is inserted forward (in the X1 direction) through the introduction port 14D of the connector 1 to the back of the receiving portion 15.

In the process of inserting the flat conductor C into the receiving portion 15, the front end of the flat conductor C comes into contact with the pressing portion 21B-1 and the contact portion 22A-1 of each terminal 20. Then, the front end of the flat conductor C presses down the pressing portion 21B-1 to elastically displace the lower elastic portion 21B downward, and presses up the contact portion 22A-1 to elastically displace the upper elastic portion 22A upward.

At the position of each locking part 38 of the movable member 30 in the connector width direction, the front end of the flat conductor C abuts against the guide surface 38A of the locking part 38 and pushes up the locking part 38. As the locking part 38 is pushed up, the movable member 30 moves upward, and accordingly, the biasing piece 42A of the metal fitting 40 is pushed up by the outer shaft part 39 of the movable member 30, and the biasing arm part 42 of the metal fitting 40 is elastically displaced upward. In other words, the upward movement of the locking part 38 is allowed by the elastic displacement of the biasing arm part 42.

At this time, as the movable member 30 moves upward, the inner shaft support portion 22B-1 of each terminal 20 is pushed up by the inner shaft part 31A of the movable member 30. That is, the upper arm part 22 of the terminal 20 is pushed up by the flat conductor C and the inner shaft part 31A of the movable member 30, and is elastically displaced upward.

In this manner, the space between the pressing portion 21B-1 and the contact portion 22A-1 of each terminal 20 is widened, and the locking part 38 of the movable member 30 moves upward, thereby allowing the flat conductor C to be inserted further forward. The flat conductor C is inserted until it abuts against the front wall 13 of the housing 10, as illustrated in FIGS. 10A and 10B.

As illustrated in FIG. 10A, in the state in which the insertion of the flat conductor C is complete, the elastically displaced state of the lower elastic portion 21B and the upper arm part 22 is maintained, and the flat conductor C is sandwiched between the pressing portion 21B-1 and the contact portion 22A-1. That is, the pressing portion 21B-1 presses the flat conductor C from below, while the contact portion 22A-1 comes into contact with the circuit part C1 (see FIG. 1) of the flat conductor C from above with contact pressure. In this way, an electrically conductive state between each terminal 20 and the flat conductor C is maintained.

As described above, in the present embodiment, when the upper arm part 22 is in a free state, the extension portion 22B is restricted from displacement in the groove width direction mainly by the groove inner surface of the first narrow portion 34B (see FIG. 9A). On the other hand, when the upper arm part 22 of the terminal 20 is in an elastically displaced state, the extension portion 22B is restricted from displacement in the groove width direction mainly by the groove inner surface of the second narrow portion 34D (see FIG. 10A). Therefore, whether the upper arm part 22 is in a free state or an elastically displaced state, the displacement of the extension portion 22B is restricted by the groove inner surface of at least one of the first narrow portion 34B and the second narrow portion 34D with a sufficient opposing area. As a result, regardless of whether the upper arm part 22 of the terminal 20 is in any of the above-mentioned states, the position of the upper arm part 22 in the connector width direction, and thus the contact position between the contact portion 22A-1 and the flat conductor C, can always be stabilized.

In the course of insertion of the flat conductor C, when the ear part C3 of the flat conductor C passes the position of the locking part 38, and the locking part 38 reaches the cut part C2, the movable member 30 returns to the closed position, and as illustrated in FIG. 9B, the locking part 38 enters into the cut part C2 from above. As a result, the locking surface 38B of the locking part 38 is positioned so as to lock the locked portion C3A of the flat conductor C from the rear, thereby suppressing the flat conductor C from being accidentally removed. The biasing arm part 42 of the metal fitting 40 returns to a free state, and the lower surface (rolled surface) of the biasing piece 42A comes into contact with the upper surface of the outer shaft part 39, and as a result, the movable member 30 is maintained in the closed position. In this way, the connection operation of the flat conductor C to the connector 1 is completed.

In order to intentionally remove the flat conductor C in the state illustrated in FIGS. 10A and 10B, that is, the flat conductor C connected to the connector 1, from the connector 1, the movable member 30 is moved from the closed position to the open position (see FIGS. 2A, 2B, 11A and 11B). Since the movable member 30 has moved to the open position, the locking part 38 of the movable member 30 is disengaged upward from the cut part C2 of the flat conductor C as illustrated in FIG. 11B, allowing the flat conductor C to be removed. Then, when the flat conductor C is pulled backward (in the X2 direction), the flat conductor C is easily removed from the connector 1, whereby the removal operation is completed.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. An electrical connector for a flat conductor to which a flat conductor is connected, the electrical connector comprising:
a housing;
a plurality of terminals; and
a movable member, wherein the plurality of terminals is held in the housing and arranged in a left-right direction perpendicular to a front-back direction and an up-down direction of the electrical connector for a flat conductor,
the movable member is movable between a closed position and an open position while rotating about a rotation axis extending in the left-right direction,
the housing is configured such that the flat conductor is insertable from rear to front of the housing,
each of the plurality of terminals has an arm part extending from the front to the rear of the housing, the arm part being able to contact the flat conductor inserted into the housing,
the movable member is configured to maintain a connection state between the electrical connector for a flat conductor and the flat conductor when being located in the closed position, and to allow removal of the flat conductor from the electrical connector for a flat conductor when being located in the open position,
the movable member has a groove that houses a rear end portion of the arm part,
the groove has a wide portion and a narrow portion narrower in groove width than the wide portion, and
when the movable member is located in a predetermined position different from the closed position, the rear end portion of the arm part is housed in the wide portion, and when the movable member is located in the closed position, the rear end portion of the arm part is housed in the wide portion and the narrow portion.

2. The electrical connector for a flat conductor according to claim 1, wherein the narrow portion has a first narrow portion located behind the wide portion and a second narrow portion located in front of the wide portion when the movable member is located in the closed position.

3. The electrical connector for a flat conductor according to claim 2, wherein
the arm part is configured to be elastically displaced in the up-down direction when in contact with the flat conductor,
when the arm part is not in contact with the flat conductor and the movable member is located in the closed position, an opposing area between the rear end portion of the arm part and a groove inner surface of the first narrow portion is larger than an opposing area between the rear end portion of the arm part and the second narrow portion, and
when the arm part is in contact with the flat conductor and the movable member is located in the closed position, the opposing area between the rear end portion of the arm part and a groove inner surface of the second narrow portion is larger than the opposing area between the rear end portion of the arm part and the first narrow portion.

4. The electrical connector for a flat conductor according to claim 1, wherein
the groove has a transition portion between the wide portion and the narrow portion, and
the transition portion is formed so as to be narrower in groove width from the wide portion toward the narrow portion.

5. The electrical connector for a flat conductor according to claim 4, wherein a groove inner surface of the transition portion forms a flat inclined surface.

6. The electrical connector for a flat conductor according to claim 1, wherein
the movable member is made of an electrically insulating material, and
a groove inner surface of the wide portion has a parting line formed by one mold placed from one side in a thickness direction of the movable member and another mold placed from the other side.
